(19) United States
(12) Patent Application Publication
(10) Pub. No.: US 2018/0229212 A1
(43) Pub. Date: Aug. 16, 2018

(54) ADSORPTION TOWER FOR OXYGEN GENERATING SYSTEM CONTAINING TWO KINDS OF ADSORBING AGENTS FILLED THEREIN

(71) Applicant: WON Hi Tech Corp., Ansan-si (KR)

(72) Inventors: Min BAEK, Seongnam-si (KR); Ji Woong CHOI, Suwon-si (KR)

(73) Assignee: WON Hi Tech Corp., Ansan-si (KR)

(21) Appl. No.: 15/874,211

(22) Filed: Jan. 18, 2018

(30) Foreign Application Priority Data
Feb. 13, 2017 (KR) 10-2017-0019562

(51) Int. Cl. B01J 20/04; B01D 15/20; C01D 15/00

(52) U.S. Cl. CPC B01J 20/04; B01D 15/20; B01D 2257/102; B01D 2256/12; B01D 2253/112; C01D 15/00; B01D 2253/308

(57) ABSTRACT

The present disclosure provides an adsorption tower for an oxygen generator system configured to adsorb nitrogen in air and supply oxygen, the tower comprising: a housing defining an inner space therein in which an adsorbing agent is filled; a housing inlet through which air enters into the housing; an housing outlet through which air is discharged from the housing, wherein the housing inlet is opposite to the housing outlet; a sodium based adsorbing agent layer disposed in the inner space and adjacent to the housing inlet; and a lithium-based adsorbing agent layer disposed in the inner space and adjacent the housing outlet.

### CROSS-REFERENCE TO RELATED APPLICATION

This application claims the benefit of Korean patent application No. 10-2017-0019562 filed on Feb. 13, 2017, the entire content of which is incorporated herein by reference for all purposes as if fully set forth herein.

### BACKGROUND

### Field of the Present Disclosure

The present disclosure relates to an adsorption tower for an oxygen generator system, where the tower contains two types of adsorbing agents filled therein. More particularly, the present disclosure relates to an adsorption tower for an oxygen generator system, where the tower is filled with two types of adsorbing agents having improved nitrogen adsorption capability so as to achieve optimal process times and increase oxygen production.

### Discussion of Related Art

Generally, an oxygen generator system is a system configured to separate and concentrate oxygen from the atmosphere. This oxygen generator system utilizes the fact that an adsorbing agent called zeolite adsorbs a certain gas molecule. Nitrogen, which accounts for about 80% of the atmosphere, is well adsorbed by zeolite rather than oxygen is adsorbed by the zeolite. Therefore, when air is introduced into the adsorbent bed filled with the adsorbing agent, the nitrogen component is adsorbed, and the gas with reduced nitrogen component is discharged through the outlet above the bed. As a result, a main component of the gas thus discharged is oxygen.

In the above-described nitrogen adsorption process, the pressurized gas is exposed to a specific adsorbing agent, whereby only nitrogen is adsorbed by the adsorbing agent and the remaining gas is not adsorbed thereby, thus separating oxygen from air. At this time, nitrogen gradually adsorbs on zeolite, which is an adsorbing agent, and, thus, the performance of the adsorbent decreases. As a result, nitrogen must be desorbed from the adsorbing agent to restore its original performance. This process is a desorption process. In this process, some of adsorbed gas adsorbed by the adsorbing agent is recirculated at a low pressure. The adsorbed gas is removed from the adsorbing agent. As a result, the adsorbing ability of the adsorbing agent is restored by washing the adsorbing agent.

Specifically, an industrial oxygen generator system may generally include an air compressor or blower configured to deliver external air into the adsorption tower, coolers and dryers to control the temperature and humidity of the compressed air, a storage tank capable of storing air or oxygen, and the adsorption tower configured to separate oxygen and nitrogen from the compressed air.

The oxygen generator system may be classified into PSA (Pressure Swing Adsorption) based system, VSA (Vacuum Swing Adsorption) based system and VPSA (Vacuum Pressure Swing Adsorption) based system according to the configuration, arrangement and operation method of the system. In this connection, the PSA based oxygen generator system concentrates oxygen using a sodium based adsorbing agent (for example, zeolite molecular sieve: ZMS).

The oxygen generating methods have been divided based on the operating methods according to the separate equipment configuration, and the pressure conditions for the separation between nitrogen and oxygen. All such oxygen generation schemes are common to each other in that they have a separation method of separating oxygen and nitrogen from the compressed air supplied into the adsorption tower using an adsorbing agent (ZMS). This separation process commonly has a flow of pressurization→pressurization production→pressure equalization→desorption→cleaning→pressure equalization→pressurization.

Referring to FIG. 1, there is shown an oxygen generator system structure according to a conventional general method. This oxygen generator system comprises a lower pipeline 10 disposed at the lower portion of the adsorption tower and used for the delivery of pressurized air, an oxygen pipeline 11 disposed at the upper portion of the adsorption tower and used to transport the produced oxygen, and a cleaning pipe 13 for cleaning. Each of these pipes is equipped with an automatic valve to adjust the opening and closing of the pipe.

The conventional oxygen generator system described above has an oxygen production rate of 7 to 8% relative to air input. Further, the amount of air injected needs to be 12 to 15 times as much as the target amount of oxygen generation, resulting in high energy consumption. Further, only the sodium-based adsorbing agent is filled, which limits the adsorption performance. As a result, the system has been limited in terms of area reduction thereof and production cost reduction.

Recently, there is on-going development of an oxygen generator system using a lithium-based adsorbing agent with a high adsorption capacity of 21 ml/g of a nitrogen component instead of a sodium-based adsorbing agent with an adsorption capacity limited to 14 ml/g of a nitrogen component.

However, an oxygen generator system using a lithium-based adsorbing agent is a small oxygen generator system with a low-pressure environment of less than 2 bar. Thus, such a system is effective in terms of performance improvement and volume reduction. However, when the system is exposed to a high-pressure environment of 6 to 7 bar, the adsorption capacity of water is doubled, resulting in premature performance deterioration. Therefore, it is necessary to use an adsorbing agent which is relatively easy to control due to the relatively low adsorption capacity of moisture.

### PRIOR ART DOCUMENT

### Patent Literature

Patent Document 1: Korean Patent No. 10-1355161 issue date: 2014 Jan. 28

Patent Document 2: Korean Patent No. 10-0334723 issue Date: 2002 May 10

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

The purpose of the present disclosure is to provide an adsorption tower for an oxygen generator system configured to double the oxygen purity and yield while reducing the overall size of the oxygen generating system, using a lithium-based adsorbing agent that doubles the adsorption capacity thereof.

In one aspect of the present disclosure, there is provided an adsorption tower for an oxygen generator system configured to adsorb nitrogen in air and supply oxygen, the tower comprising: a housing defining an inner space therein in which an adsorbing agent is filled; a housing inlet through which air enters into the housing; an housing outlet through which air is discharged from the housing, wherein the housing inlet is opposite to the housing outlet; a sodium based adsorbing agent layer disposed in the inner space and adjacent to the housing inlet; and a lithium-based adsorbing agent layer disposed in the inner space and adjacent the housing outlet.

In one embodiment, the housing is operated at an a pressure in a range of about 5 to 8 bars such that the discharged oxygen is pressurized into a range of about 3 to 4 bars.

In one embodiment, the sodium-based adsorbing agent layer is filled into the housing at about 20 to 30% by volume based on 100% by volume of the inner space of the housing, and the lithium-based adsorbing agent layer is filled into the housing at about 70 to 80% by volume based on 100% by volume of the inner space of the housing.

In one embodiment, the sodium-based adsorbing agent layer has pores formed therein, wherein an average diameter of the pores is in a range of about 0.9 nm to 1.0 nm.

In one embodiment, the tower further comprises strainers configured to prevent loss of the sodium-based adsorbing agent layer and the lithium-based adsorbing agent layer and to pass air therethrough, wherein the strainers include a first strainer disposed adjacent to the housing inlet and disposed on the sodium-based adsorbing agent layer and include a second strainer disposed adjacent to the housing outlet and disposed on the lithium-based adsorbing agent layer.

In the oxygen generator system equipped with the adsorption tower according to the present disclosure, the oxygen productivity increases to be in a range of 9 to 10% relative to the air input amount, and the air injection amount needs 10 to 12 times the target oxygen amount.

Further, the adsorption tower according to the present disclosure includes a sodium-based adsorbing agent and a lithium-based adsorbing agent in a multi-layered form. As a result, the sodium-based adsorbing agent at a lower layer adsorbs moisture and nitrogen molecules that are relatively easy to be attached and detached. The lithium-based adsorbing agent deposited as the upper layer causes a pretreatment process to facilitate the normal gas separation process. As a result, the lithium-based adsorbing agent is prevented from adsorbing the moisture even under high-pressure operation, so that stable adsorption performance of nitrogen thereof may be maintained.

In addition, the adsorption tower according to the present disclosure exhibits high performance and high efficiency, and thus, may be reduced in size by 50% or more compared to the conventional adsorption tower, thereby reducing the installation space constraint.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 is a diagram showing a conventional oxygen generator system.

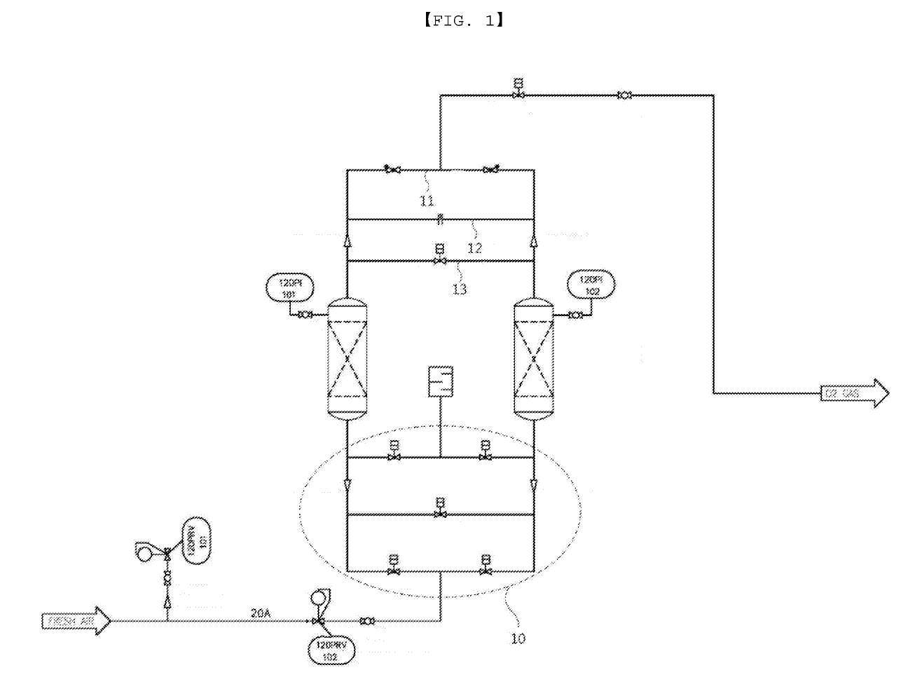

FIG. 2 is a cross-sectional view illustrating an adsorption tower for an oxygen generator system according to the present disclosure.

### DETAILED DESCRIPTIONS

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

Hereinafter, with reference to the accompanying drawings, an adsorption tower for an oxygen generator system having two types of adsorbing agents filled therein using preferred embodiments of the present disclosure will be described in detail. In this connection, an adsorption tower for an oxygen generator system having two types of adsorbing agents filled therein will be abbreviated as an adsorption tower for an oxygen generator system.

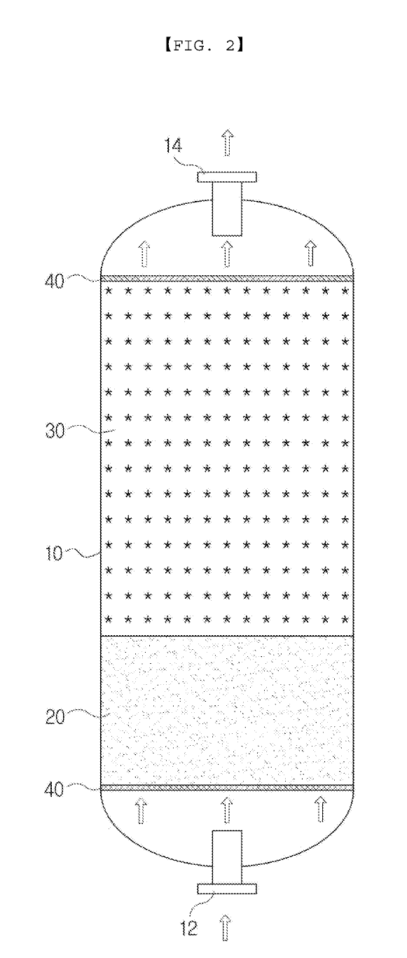

FIG. 2 is a cross-sectional view illustrating an adsorption tower for an oxygen generator system according to the present disclosure.

Referring to FIG. 2, the adsorption tower for the oxygen generator system according to the present disclosure includes a housing 10 defining a space therein in which an adsorbing agent is filled; a sodium based adsorbing agent layer 20 disposed adjacent to a housing inlet 12 through which air enters into the housing 10; and a lithium-based adsorbing agent layer 30 disposed adjacent an housing outlet 14 through which air is discharged from the housing 10.

Hydrogen, carbon monoxide, carbon dioxide, hydrocarbons, nitrogen, and oxygen are adsorbed in this order while the air passes through the adsorption tower for the oxygen generator system. Thus, oxygen with the relatively low adsorption is rich in a discharged gas.

Hereinafter, components of the adsorption tower for an oxygen generator system according to the present disclosure will be described in more detail with reference to the drawings.

Referring to FIG. 2, the adsorption tower for an oxygen generator system according to the present disclosure includes the housing 10.

The housing 10 defines the shape or appearance of the adsorption tower for the oxygen generator system. The housing has an inlet 12 formed at its lower end and an outlet 14 formed at its upper end. The housing may be formed in a closed cylindrical shape. However, this disclosure is not limited to this.

This housing 10 defines the space within which the adsorbing agent is filled. Within this space is filled an adsorbing agent, preferably a solid state adsorbing agent, which preferentially adsorbs a specific gas in air. In this connection, a sodium based adsorbing agent layer 20 and a lithium based adsorbing agent layer 30 are used as the adsorbing agent.

Further, the housing 10 is connected to a supply valve (not shown) of the oxygen generator system. The compressed air passes through the supply valve. The specific gas is separated from the compressed air introduced into the inlet 12 of the housing by the adsorbing agents in the housing. As a result, the gas excluding the specific gas from the air is discharged through the outlet 14 of the housing.

In this manner, the inlet 12 into which air supplied from an external air compressor or blower flows is formed on one side of the housing. The outlet 14 through which air passing through the inside of the housing 10 is discharged is formed on the other side opposite to the one side. In this example, one side is a lower side while the other side is an upper side.

If necessary, a pressure gauge (not shown) may be provided at one side of the housing 10 to detect and display the pressure change inside the housing 10 at any time. This allows the user to easily check the pressure change inside the adsorption tower.

Referring to FIG. 2, the adsorption tower for the oxygen generator system according to the present disclosure includes the sodium-based adsorbing agent layer 20. The sodium-based adsorbing agent layer 20 may adsorb moisture in the air introduced into the housing 10 first. To this end, the sodium-based adsorbing agent layer 20 is disposed adjacent the inlet 12 of the housing 10. The sodium-based adsorbing agent layer 20 includes sodium-based adsorbing agents made of powders or granular forms.

The sodium-based adsorbing agent layer 20 may include a sodium-X based agent such as an alkali alumino silicate having excellent water adsorption. In this connection, the sodium-X based adsorbing agent has an average pore diameter of 0.9 nm to 1 nm.

More specifically, the sodium-based adsorbing agent layer 20 may be filled into the housing 10 at 20 to 30% by volume based on 100% by volume of the internal space of the housing. In this connection, if the sodium-based adsorbing agent layer 20 is filled in the housing 10 at less than 20 vol %, water contained in the air cannot be sufficiently removed, which may lead to excessive adsorption of water on the lithium-based adsorbing agent under high-pressure operation. Further, when the sodium-based adsorbing agent layer 20 is filled in the housing 10 such that the sodium-based adsorbing agent layer 20 is more than 30% by volume, the filling amount of the lithium-based adsorbing agent layer 30 is decreased. Thus, there may be a problem that the amount of air injected increases with respect to the target oxygen amount.

Referring to FIG. 2, the adsorption tower for an oxygen generator system according to the present disclosure includes the lithium-based adsorbing agent layer 30.

The lithium-based adsorbing agent layer 30 adsorbs air from which moisture and carbon dioxide, carbon dioxide, hydrocarbons, and a certain amount of nitrogen is removed by the sodium-based adsorbing agent layer 20. To this end, the lithium-based adsorbing agent layer 30 is disposed adjacent to the outlet 14 of the housing 10. The lithium-based adsorbing agent layer 30 may be in the form of powder or granules of the lithium-based adsorbing agent.

When the lithium-based adsorbing agent alone is filled in the housing 10, the housing has efficient adsorbing in a low-pressure operation of less than 2 bar. However, in the operation under the high pressure of 5 to 6 bar, especially 5 to 8 bar, the adsorption ability to moisture is doubled, and, thus, the early adsorption of moisture in the proper process time occurs. As a result, a difficulty arises in process control. In this connection, operating at a relatively high pressure of 5 to 6 bar, rather than 2 bar, may bring the produced oxygen pressure to around 3 to 4 bar.

This is advantageous for the following reasons. In the low-pressure production facility, the oxygen pressure produced is as low as 0.2 to 0.5 bar, thus, the oxygen compressor for boosting the pressure should be used. In this connection, a device must be built to cope with the risk of compression, and an expensive oxygen compressor should be used. Otherwise, when the present approach is used, the above requirement may be removed.

In other words, the lithium-based adsorbing agent layer 30 filled in the adsorption tower according to the present disclosure contacts the air from which water and carbon dioxide, carbon dioxide, hydrocarbons, and nitrogen are firstly removed by the sodium-based adsorbing agent layer 20. As a result, even when the adsorption capacity of water is doubled in a high-pressure operation, since the adsorption amount of moisture is small, a normal gas separation step is smoothly carried out, and nitrogen gas is adsorbed smoothly.

In certain embodiments, the lithium-based adsorbing agent 30 may include the lithium-based adsorbing agent which may be Z10-05-03 available from Zeochem, NSA-700 available from Tosoh.

Referring to FIG. 2, the adsorption tower for an oxygen generator system according to the present disclosure may further include a strainer 40.

The strainer 40 is configured to prevent loss of the sodium-based adsorbing agent layer 20 and the lithium-based adsorbing agent layer 30 and to pass air therethrough.

The strainer 40 is disposed on the bottom face of the sodium-based adsorbing agent layer 20 and on the top face of the lithium-based adsorbing agent layer 30. Specifically, the strainer 40 includes a first strainer 40 disposed on the bottom face of the sodium-based adsorbing agent layer 20 and a second strainer 40 disposed on the top face of the lithium-based adsorbing agent layer 30.

The strainer 40 has perforations having diameters smaller than the diameter of the particles of the sodium-based adsorbing agent layer 20 and the particles of the lithium-based adsorbing agent layer 30 to pass air and block the adsorbing agent.

Further, the first strainer 40 is installed at a predetermined distance from the inlet 12 of the housing 10 so that the air introduced into the housing 10 through the inlet 12 of the housing 10 may be uniformly contacted to the sodium-based adsorbing agent layer 20. The second strainer 40 is preferably spaced apart from the outlet 14 of the housing 10 so that the air passing through the lithium-based adsorbing agent layer 30 may be stably discharged through the outlet 14 of the housing 10.

If necessary, the strainer 40 may be formed of aluminum, stainless steel, or the like so as to prevent corrosion due to moisture in the air, or may be formed of a metal coated with aluminum on its surface.

The following is a more detailed description of the present disclosure via the specific embodiment and the present example. It should be understood, however, that the embodiments and the present examples are provided for a better understanding of the specific examples of the invention described above and should not be construed as limiting the scope of the claims.

Manufacturing of Oxygen Generator System

The oxygen generator system is manufactured. The oxygen generator system includes an air inlet, an air compressor, a water filter, a merging filter, an air regulator, a first pressure gauge, a first safety valve, a supply valve, and a silencer. The system also includes a first adsorption tower, a second adsorption tower, a circulation valve connecting the outlet of the first adsorption tower to the inlet of the second adsorption tower and the outlet of the second adsorption tower and the inlet of the first adsorption tower. The system includes a first flow control valve, a second flow control valve, a first discharge valve, a second discharge valve, a check valve, a needle valve, a second pressure gauge, a storage tank, a third pressure gauge, a second safety valve, a pressure switch, and a control unit.

In this connection, the oxygen generator system is as disclosed in an oxygen generator system published by Wonhightech corporation as disclosed in Korean Patent No. 10-0861550.

### Embodiment 1

The applicants fill 30% of the sodium-X based adsorbing agent [Z10-04, Zeochem, Swiss] adjacent to the inlet of each of the first adsorption tower and the second adsorption tower. The remaining 70 vol % was filled with a lithium-based adsorbing agent [Z10-05-03, Zeochem, Swiss].

### Embodiment 2

The applicants fill 25% of the sodium-X based adsorbing agent [Z10-04, Zeochem, Swiss] adjacent to the inlet of each of the first adsorption tower and the second adsorption tower. The remaining 75 vol % was filled with a lithium-based adsorbing agent [Z10-05-03, Zeochem, Swiss].

### Comparison Example 1

The housings in the first adsorption tower and the second adsorption tower are filled with 100% by volume of the lithium-based adsorbing agent [Z10-05-03, Zeochem, Swiss], wherein the agent is in a non-used state.

### Comparison Example 2

The housings in the first adsorption tower and the second adsorption tower are filled with 100% by volume of the lithium-based adsorbing agent [Z10-05-03, Zeochem, Swiss], wherein the agent is in a used state.

### Comparison Example 3

The applicants fill 30% of the sodium-A based adsorbing agent [Z4-01, Zeochem, Swiss] adjacent to the inlet of each of the first adsorption tower and the second adsorption tower. The remaining 70 vol % was filled with a lithium-based adsorbing agent [Z10-05-03, Zeochem, Swiss].

[Evaluation Test]

When the oxygen generator systems are operated using the embodiments 1 and 2 and the comparison examples 1 to 3, so that 90% concentration of oxygen is stored in the storage tank, the applicants evaluate the moisture adsorption rate of the adsorbing agents via a functional evaluation experiment. The results thereof are shown in Table 1 below.

TABLE 1
Evaluation results of moisture adsorption rates of adsorption towers

| | Present embodiments | | Comparison examples | | |
|---|---|---|---|---|---|
| Agents | 1 | 2 | 1 | 2 | 3 |
| Lithium | 0.2372 | 0.8556 | 0.1 | 2.617 | 6.3794 |
| Sodium-X | 7.2508 | 6.2393 | | | |
| Sodium-A | | | | | 1.4925 |

As shown in Table 1, when only the lithium-based adsorbing agent is filled in the adsorption tower, at the beginning, the water adsorption rate was remarkably low, but the water adsorption rate was found to increase sharply with repeated use.

Further, when the sodium-X based adsorbing agent is filled at 25 vol % and 30 vol %, respectively, the water absorption on the lithium-based adsorbing agent was significantly reduced. In this connection, the moisture removal rate of the sodium-X based adsorbing agent is confirmed to be excellent.

In addition, the sodium-A based adsorbing agent had significantly lower water adsorption capacity than the sodium-X based adsorbing agent. As a result, it was found that excessive adsorption of water on the lithium-based adsorbing agent occurred using the former agent.

That is, when the adsorption tower is used repeatedly, a stack of a sodium-X based adsorbing agent layer and a lithium-based adsorbing agent layer must be used such that the efficiency of nitrogen adsorption of the lithium-based adsorbing agent may be improved.

While the foregoing description of the present disclosure has been provided with reference to preferred embodiments of the present disclosure, those skilled in the art will appreciate that various modifications and changes may be made to the present disclosure without departing from the spirit and scope of the present disclosure set forth in the claims that follow.

What is claimed is:

1. An adsorption tower for an oxygen generator system configured to adsorb nitrogen in air and supply oxygen, the tower comprising:
a housing defining an inner space therein in which an adsorbing agent is filled;
a housing inlet through which air enters into the housing;
an housing outlet through which air is discharged from the housing, wherein the housing inlet is opposite to the housing outlet;
a sodium based adsorbing agent layer disposed in the inner space and adjacent to the housing inlet; and
a lithium-based adsorbing agent layer disposed in the inner space and adjacent the housing outlet,
wherein the housing is operated at an a pressure in a range of about 5 to 8 bars such that the discharged oxygen is pressurized into a range of about 3 to 4 bars,
wherein the sodium-based adsorbing agent layer is filled into the housing at about 20 to 30% by volume based on 100% by volume of the inner space of the housing,
wherein the lithium-based adsorbing agent layer is filled into the housing at about 70 to 80% by volume based on 100% by volume of the inner space of the housing.

2. The tower of claim 1, wherein the sodium-based adsorbing agent layer has pores formed therein, wherein an average diameter of the pores is in a range of about 0.9 nm to 1.0 nm.

3. The tower of claim 1, further comprising strainers configured to prevent loss of the sodium-based adsorbing agent layer and the lithium-based adsorbing agent layer and to pass air therethrough,
wherein the strainers include a first strainer disposed adjacent to the housing inlet and disposed on the sodium-based adsorbing agent layer and include a second strainer disposed adjacent to the housing outlet and disposed on the lithium-based adsorbing agent layer.
